(19) United States
(12) Patent Application Publication
(10) Pub. No.: US 2024/0159656 A1
(43) Pub. Date: May 16, 2024

(54) COMBINED MODELING AND MACHINE LEARNING IN OPTICAL METROLOGY

(71) Applicant: Onto Innovation Inc., Wilmington, MA (US)

(72) Inventors: Pei Fen Teh, Singapore (SG); Rajaram Attukur Nandagopal, Singapore (SG); Youxian Wen, Fremont, CA (US)

(73) Assignee: Onto Innovation Inc., Wilmington, MA (US)

(21) Appl. No.: 18/503,783

(22) Filed: Nov. 7, 2023

Related U.S. Application Data
(60) Provisional application No. 63/424,808, filed on Nov. 11, 2022.

(51) Int. Cl. G01N 21/21

(52) U.S. Cl. CPC G01N 21/211

(57) ABSTRACT

Complex three-dimensional structures in semiconductor devices are measured using Mueller matrix paired off-diagonal elements to generate machine learning predictions of asymmetric parameters of the device and determine dimensional parameters based on one or more Mueller matrix elements and the asymmetric parameters. The measurements of the device may be performed at different azimuth angles selected based on sensitivity to the asymmetric parameters and the dimensional parameters. Additionally, the Mueller matrix elements may be generated based on measurements performed at azimuth angles that are 180° apart to eliminate asymmetric noise from the measurement tool. One or more models of the device may be used with the Mueller matrix elements to generate dimensional parameter information and optionally preliminary asymmetrical parameters. The determined asymmetric parameters may be fed forward to the one or more models for determining the dimensional parameters to suppress a correlation between dimensional parameters and asymmetric parameters of the device.

### CLAIM OF PRIORITY

This application claims the benefit of and priority to U.S. Provisional Application No. 63/424,808, filed Nov. 11, 2022, and entitled “COMBINED MODELING AND MACHINE LEARNING IN OPTICAL METROLOGY,” which is assigned to the assignee hereof and is incorporated herein by reference in its entirety.

### FIELD OF THE DISCLOSURE

Subject matter described herein is related generally to optical metrology, and more particularly to the use of combined modeling and machine learning techniques for measurement of structures.

### BACKGROUND

Semiconductor and other similar industries often use optical metrology equipment to provide non-contact evaluation of samples during processing. With optical metrology, a sample under test is illuminated with light, e.g., at a single wavelength or multiple wavelengths. After interacting with the sample, the resulting light is detected and analyzed to determine one or more characteristics of the sample.

The analysis typically includes a model of the structure under test. The model may be generated based on the materials and the nominal parameters of the structure, e.g., film thicknesses, line and space widths, etc. One or more parameters of the model may be varied and the predicted data may be calculated for each parameter variation based on the model, e.g., using Rigorous Coupled Wave Analysis (RCWA) or other similar techniques. The measured data may be compared to the predicted data for each parameter variation, e.g., in a nonlinear regression process, until a good fit is achieved between the predicted data and the measured data, at which time the fitted parameters are determined to be an accurate representation of the parameters of the structure under test. Modeling, however, may be time consuming and computationally intensive, and expensive, particularly for complex features.

### SUMMARY

In implementations discussed herein, complex three-dimensional (3D) structures in semiconductor devices may be measured, e.g., using spectroscopic ellipsometry, to obtain Mueller matrix paired off-diagonal elements from which machine learning predictions of asymmetric parameters of the device may be generated and from which dimensional parameters may be generated based on one or more Mueller matrix elements and the asymmetric parameters. Measurements of the device may be performed at a plurality of azimuth angles selected based on sensitivity to the asymmetric parameters and the dimensional parameters. Additionally, measurements may be performed using azimuth angles that are 180° apart and the Mueller matrix elements determined based on a difference in the measurements performed at the azimuth angles that are 180° apart. One or more models of the device may be used with the Mueller matrix elements to generate dimensional parameter information, and in some implementations to generate asymmetrical parameter information. The determined asymmetric parameters may be fed forward for determining the dimensional parameters to suppress a correlation between dimensional parameters and asymmetric parameters of the device.

In one implementation, a method for measuring a three-dimensional (3D) device on a sample, includes obtaining a plurality of Mueller matrix elements from ellipsometry measurements of the 3D device. Machine learning predictions of asymmetric parameters of the 3D device are generated based on at least one Mueller matrix paired off-diagonal elements from the plurality of Mueller matrix elements. Additionally, dimensional parameters of the 3D device are generated based on one or more Mueller matrix elements from the plurality of Mueller matrix elements and the asymmetric parameters of the 3D device.

In one implementation, an apparatus for measuring a three-dimensional (3D) device on a sample includes a means for obtaining a plurality of Mueller matrix elements from ellipsometry measurements of the 3D device. The apparatus may further include a means for generating machine learning predictions of asymmetric parameters of the 3D device based on at least one Mueller matrix paired off-diagonal elements from the plurality of Mueller matrix elements. Additionally, the apparatus may further include a means for generating dimensional parameters of the 3D device based on one or more Mueller matrix elements from the plurality of Mueller matrix elements and the asymmetric parameters of the 3D device.

In one implementation, an apparatus for measuring a three-dimensional (3D) device on a sample, includes at least one memory and a processing system including one or more processors coupled to the at least one memory. The processing system is configured to obtain a plurality of Mueller matrix elements from ellipsometry measurements of the 3D device. The processing system is further configured to generate machine learning predictions of asymmetric parameters of the 3D device based on at least one Mueller matrix paired off-diagonal elements from the plurality of Mueller matrix elements. Additionally, the processing system is further configured to generate dimensional parameters of the 3D device based on one or more Mueller matrix elements from the plurality of Mueller matrix elements and the asymmetric parameters of the 3D device.

### BRIEF DESCRIPTION OF THE DRAWINGS

FIG. 1 illustrates an example of process-induced errors produced during fabrication of a complex three-dimensional (3D) structure.

FIG. 2 illustrates a schematic view of an optical metrology device that may be used to generate metrology data from a test sample and to process the metrology data.

FIGS. 3A and 3B illustrates a cross sectional view and top view, respectively, of a device structure during measurement and determining sensitivity for key parameters.

FIG. 4A and 4B respectively illustrate a top view of a device structure measured at azimuth angles that are 180° apart and an example of the resulting measurement signals.

FIG. 4C illustrates the removal of the tool induced shift from Mueller matrix paired off-diagonal elements.

FIGS. 5A and 5B respectively illustrate graphs of Mueller matrix paired off-diagonal element signal measurements and associated asymmetric parameters of a complicated 3D device structure.

FIGS. 6A and 6B respectively illustrate graphs of Mueller matrix off-diagonal element signal measurements for dimensional parameters and associated dimensional parameters of a complicated 3D device structure.

FIG. 6C illustrates Mueller matrix paired off-diagonal element signal measurements for dimensional parameters of the complicated 3D device structure shown in FIG. 6B when the model is symmetric.

FIG. 6D illustrates Mueller matrix paired off-diagonal element signal measurements for dimensional parameters of the complicated 3D device structure shown in FIG. 6B when the model is asymmetric.

FIGS. 7A and 7B respectively illustrate graphs of Mueller matrix off-diagonal element signal measurements and associated asymmetric parameters of a complicated 3D device structure.

FIG. 8A illustrates a workflow for determining asymmetry parameters and dimensional parameters in accordance with a first example scenario.

FIG. 8B is a flow chart illustrating a process for training the machine learning models.

FIG. 9 illustrates a workflow for determining asymmetry parameters and dimensional parameters in accordance with a second example scenario.

FIG. 10 is a flow chart illustrating a method for measuring a three-dimensional (3D) device on a sample.

### DETAILED DESCRIPTION

During fabrication of semiconductor and similar devices it is very often necessary to monitor the fabrication process by non-destructively measuring the devices. Optical metrology may be employed for non-contact evaluation of samples during processing. As device structures decrease in size and increase in complexity, accurate inline optical metrology solutions become increasingly critical.

By way of example, transistor fabrication has progressed from devices such as FinFET to Gate-all-around (GAA) to Forksheet (FS) devices, each adding complexity challenges to inline measurement during fabrication. Forksheet, for example, is one of the next generation logic devices with the key scaling boosters on tighter PMOS and NMOS separation than FinFET and GAA devices. With Forksheet, the PMOS and NMOS are separated by a dummy wall material. Therefore, device performance for Forksheet is determined by shallow trench isolation (STI) PMOS/NMOS critical dimensions (CDs) and wall dielectric CD, which requires efficient and accurate inline metrology solution. Fabrication of complex structures, such as Forksheet devices, may lead to patterning process errors like overlay, varying epitaxial (EPI) germanium (GE) percentage growth rate, and work function metal (WFM) coat rate, pitch walk with other asymmetric parameters. Therefore, it is desirable to enable the metrology technique to accurately measure both the geometric parameters (CD, HT, SWA) and the process induced error dimensions for any such complex structures.

One metrology technique that may be used to non-destructively characterize complicated three-dimensional (3D) semiconductor devices is Mueller Matrix Spectroscopic Ellipsometry (MMSE). An MMSE, or other similar metrology device, generates a 4×4 square Mueller Matrix (MM) that is used to relate the stokes vector of the incident and reflected light beam off the sample device, which may be used to measure geometric information, including asymmetries. Modeling of the structure may be to generate predicted data (e.g., MM signals) that is to be compared with the measured data from the sample. Variable parameters in the model, such as layer thicknesses, line widths, space widths, sidewall angles, material properties, etc., may be varied and predicted data generated for each variation. The measured data may be compared with the predicted data for each parameter variation, e.g., in a nonlinear regression process, until a good fit is achieved, at which time the values of the fitted parameters are determined to be an accurate representation of the parameters of the sample.

If a complex structure, such as a Forksheet structure becomes asymmetric due to process induced errors, the MM signals may be used to characterize the process errors. However, use of MM signals to characterize complicated 3D devices is challenging to differentiate dimensional parameters (e.g., height, line width, side wall angle, etc.) and asymmetric parameters (e.g., overlay, odd/even CDs, pitch walk, etc.) simultaneously. The MM signals, for example, are equally influenced by asymmetries and dimensional parameters, which makes it difficult to break the correlation between dimensional and asymmetric parameters.

As discussed herein, an optical metrology technique may measure asymmetric parameters based on the spectral response of MM signals using a machine learning approach, which may be combined, e.g., feed forward, to a modeling approach that is used to further improve the measurement accuracy of the dimensional parameters. The asymmetric data feed forward to the model will suppress the correlation between dimensional and asymmetric parameters, resulting in an improved model accuracy and better device performance. For example, in some implementations, paired off-diagonal MM elements may be used to break the correlation between dimensional and asymmetric parameters in a device model, which may be combined with the hybrid machine learning and modeling metrology technique to produce an efficient metrology solution that improves the accuracy efficiently and effectively.

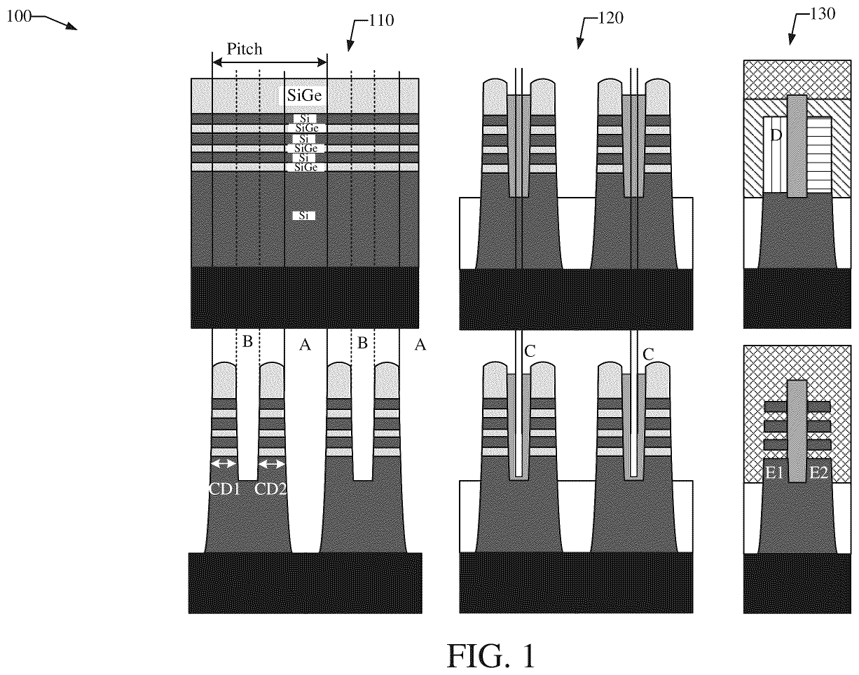

FIG. 1, by way of example, illustrates an example of process-induced errors during fabrication of a complex structure. FIG. 1 illustrates the fabrication of a Forksheet device 100 as an example of a complex structure, but it should be understood that process-induced errors may be generated during fabrication of other complex structures, including finFETs and GAAs. The metrology techniques discussed herein are sometimes in reference to a Forksheet device and process-induced errors produced during the fabrication of a Forksheet device, but the metrology techniques are not limited to use with a Forksheet device, but may be used with any desired device in which it may be desirable to break the correlation between dimensional and asymmetric parameters.

FIG. 1 illustrates fabrication of the Forksheet device 100 including Fin formation including Nanosheet (NS) patterning 110, dielectric wall etch back 120, and work function metal (WFM) formation 130. During fabrication of the Forksheet device 100 several patterning process errors may occur. For example, during NS patterning 110, patterning process errors of pitch walking (A), and overlay (B) may occur. During the dielectric wall etch back 120, an overlay (C) process error may occur. During the WFM formation 130, process errors including different EPI growth rate (D) and different WFM coat rate (E) may occur.

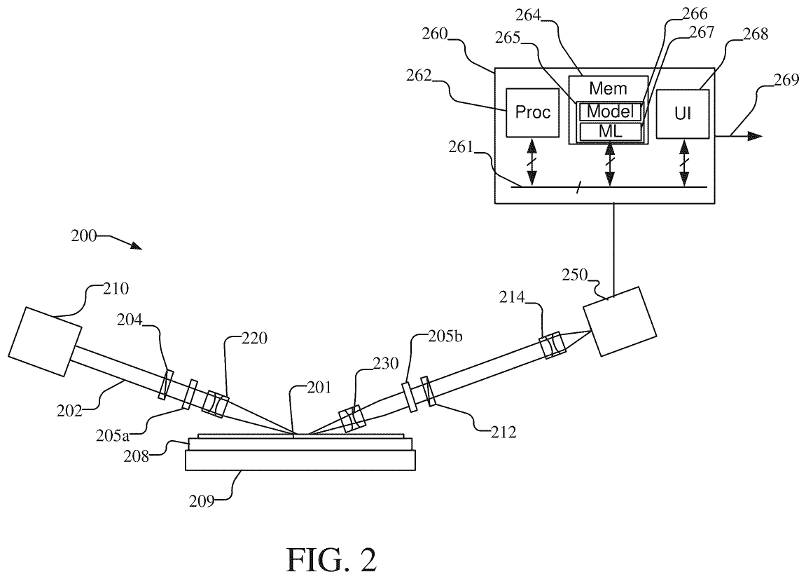

FIG. 2, by way of example, illustrates a schematic view of an optical metrology device 200 that may be used to generate metrology data from a test sample and to process the metrology data, as described herein. The optical metrology device 200 may be configured to perform measurements of a sample 201 that may be analyzed as discussed herein. For example, the optical metrology device 200 may be monochromatic or spectroscopic metrology device, such as, e.g., ellipsometer, spectroscopic ellipsometer, reflectometer, spectroscopic reflectometer, scatterometer, spectroscopic scatterometer, etc. The optical metrology device 200, for example, may be configured to produce partial or full Mueller matrix measurements. It should be understood that optical metrology device 200 is illustrated as one example of a metrology device, and that if desired other metrology devices may be used, including normal incidence devices, etc.

Optical metrology device 200 includes a light source 210 that produces light 202. The light 202, for example, UV-visible or near infrared light with wavelengths, e.g., between 190 nm and 1700 nm. The light 202 produced by light source 210 may include a range of wavelengths, i.e., continuous range or a plurality of discrete wavelengths, or may be a single wavelength. The optical metrology device 200 includes focusing optics 220 and 230 that focus and receive the light and direct the light to be obliquely incident on a top surface of the sample 201. The focusing optics 220, 230 may be refractive, reflective, or a combination thereof and may be an objective lens.

The reflected light may be focused by lens 214 and received by a detector 250. The detector 250, may be a conventional charge coupled device (CCD), photodiode array, CMOS, or similar type of detector. The detector 250 may be, e.g., a spectrometer if broadband light is used, and detector 250 may generate a spectral signal as a function of wavelength. A spectrometer may be used to disperse the full spectrum of the received light into spectral components across an array of detector pixels. One or more polarizing elements may be in the beam path of the optical metrology device 200. For example, optical metrology device 200 may include one or both of one or more polarizing elements in the beam path before the sample 201, such as polarizer 204 and a rotating compensator 205a (or photoelastic modulator), and one or more polarizing elements in the beam path after the sample 201, such as analyzer 212 and a rotating compensator 205b (or photoelastic modulator). With the use of a spectroscopic ellipsometer using dual rotating compensators 205a and 205b, between polarizing elements 204 and 212 and the sample, a full 4×4 square Mueller matrix (MM) may be measured.

Optical metrology device 200 further includes one or more computing systems 260 that is configured to perform measurements of one or more parameters of the sample 201 using the methods described herein. The one or more computing systems 260 is coupled to the detector 250 to receive the metrology data acquired by the detector 250 during measurement of the structure of the sample 201. The acquisition of data may be post-processing, as well as pre-processing. The one or more computing systems 260, for example, may be a workstation, a personal computer, central processing unit or other adequate computer system, or multiple systems. The one or more computing systems 260 may be configured to perform optical metrology based on spectral processing or feature extraction to eliminate or reduce undesired spectral signals, e.g., in accordance with the methods described herein.

It should be understood that the one or more computing systems 260 may be a single computer system or multiple separate or linked computer systems, which may be interchangeably referred to herein as computing system 260, at least one computing system 260, one or more computing systems 260. The computing system 260 may be included in or is connected to or otherwise associated with optical metrology device 200. Different subsystems of the optical metrology device 200 may each include a computing system that is configured for carrying out steps associated with the associated subsystem. The computing system 260, for example, may control the positioning of the sample 201, e.g., by controlling movement of a stage 209 that is coupled to the chuck. The stage 209, for example, may be capable of horizontal motion in either Cartesian (i.e., X and Y) coordinates, or Polar (i.e., R and θ) coordinates or some combination of the two. The stage may also be capable of vertical motion along the Z coordinate. The computing system 260 may further control the operation of the chuck 208 to hold or release the sample 201. The computing system 260 may further control or monitor the rotation of one or more polarizing elements, e.g., polarizer 204, analyzer 212, compensators 205a, 205b, etc.

The computing system 260 may be communicatively coupled to the detector 250 in any manner known in the art. For example, the one or more computing systems 260 may be coupled to separate computing systems that is associated with the detector 250. The computing system 260 may be configured to receive and/or acquire metrology data or information from one or more subsystems of the optical metrology device 200, e.g., the detector 250, as well as controllers polarizing elements 204, 212, and compensator(s) 205a, 205b, etc., by a transmission medium that may include wireline and/or wireless portions. The transmission medium, thus, may serve as a data link between the computing system 260 and other subsystems of the optical metrology device 200.

The computing system 260, which includes a processing system having at least one processor 262 that is coupled with memory 264, as well as a user interface (UI) 268, which are communicatively coupled via a bus 261. The memory 264 or other non-transitory computer-usable storage medium, includes computer-readable program code 265 embodied thereof and may be used by the computing system 260 for causing the at least one computing system 260 to control the optical metrology device 200 and to perform the functions including the analysis described herein, including performing machine learning techniques and modeling techniques to characterize asymmetric parameters and dimensional parameters of the 3D devices. For example, as illustrated, memory 264 may include instructions for causing the at least one processor 262 to perform both modeling (Model 266) and machine learning (ML 267), and in some implementations, may employ feedforward and/or feedback, as discussed herein. The data structures and software code for automatically implementing one or more acts described in this detailed description can be implemented by one of ordinary skill in the art in light of the present disclosure and stored, e.g., on a computer-usable storage medium, e.g., memory 264, which may be any device or medium that can store code and/or data for use by a computer system, such as the computing system 260. The computer-usable storage medium may be, but is not limited to, include read-only memory, a random access memory, magnetic and optical storage devices such as disk drives, magnetic tape, etc. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described.

As discussed herein, the computing system 260, for example, may be configured to obtain measurements, e.g., spectroscopic ellipsometric measurements, from a 3D device structures, such as a FinFET device, a GAA device, Forksheet device, or other complicated 3D device structures. The computing system 260 may be configured to generate a plurality of Mueller matrix elements based on the measurements. The computing system 260, for example, may generate one or more Mueller matrix elements and one or more Mueller matrix paired off-diagonal elements. The computing system 260 may be configured to generate machine learning predictions of asymmetric parameters of the 3D device based on at least one Mueller matrix paired off-diagonal elements from the plurality of Mueller matrix elements and to generate dimensional parameters of the 3D device, e.g., using one or more of Optical Critical Dimension (OCD) modelling and machine learning modelling, based on one or more Mueller matrix elements from the plurality of Mueller matrix elements and the asymmetric parameters of the 3D device, as discussed herein.

The results from the analysis of the data may be reported, e.g., stored in memory 264 associated with the sample 201 and/or indicated to a user via user interface (UI) 268, an alarm or other output device. Moreover, the results from the analysis may be reported and fed forward or back to the process equipment to adjust the appropriate fabrication steps to compensate for any detected variances in the fabrication process. The computing system 260, for example, may include a communication port 269 that may be any type of communication connection, such as to the internet or any other computer network. The communication port 269 may be used to receive instructions that are used to program the computing system 260 to perform any one or more of the functions described herein and/or to export signals, e.g., with measurement results and/or instructions, to another system, such as external process tools, in a feed forward or feedback process in order to adjust a process parameter associated with a fabrication process step of the samples based on the measurement results.

Ellipsometry typically examines the changes in the p- and s-components of light caused by reflection or transmission from a sample. For example, light having a known polarization state is produced and incident on the sample and the resulting change in the polarization state is measured. The change in polarization state is typically written as follows:

$$\\ \begin{matrix}{R}_{p} = \frac{{E}_{p}^{{}^{} ′}}{{E}_{p}} ; {R}_{s} = \frac{{E}_{s}^{{}^{} ′}}{{E}_{s}} . & Eq . 1\end{matrix}$$

In equation 1, Eₚ and Eₛ are the electrical vectors for the respective parallel and perpendicular components of the elliptically polarized incident light and E′ₚ and E′ₛ are the parallel and perpendicular components, respectively, of the elliptically polarized reflected light, and Rₚ and Rₛ are the reflection coefficients of the sample for the parallel and perpendicular components of light.

In some implementations, using at least several specific elements from the Mueller matrix produced by optical metrology device 200, the asymmetry of a structure may be measured. The Mueller matrix M is a 4×4 matrix that describes the sample being measured and may be written as follows.

$$\\ \begin{matrix}M = ( \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ {m}_{41} & {m}_{42} & {m}_{43} & {m}_{44}\end{matrix} ) . & Eq . 2\end{matrix}$$

The Mueller matrix is related to the Jones matrix J, where J * is the complex conjugate of J, as follows.

M=T(U⊗J*)T⁻¹ Eq. 3

The Jones matrix describes the sample-light interaction as follows.

$$\\ \begin{matrix}J = [ \begin{matrix}{r}_{pp} & {r}_{ps} \\ {r}_{sp} & {r}_{ss}\end{matrix} ] & Eq . 4\end{matrix}$$

$$\\ \begin{matrix}[ \begin{matrix}{E}_{p}^{{}^{} ′} \\ {E}_{s}^{{}^{} ′}\end{matrix} ] = [ \begin{matrix}{r}_{pp} & {r}_{ps} \\ {r}_{sp} & {r}_{ss}\end{matrix} ] [ \begin{matrix}{E}_{p} \\ {E}_{s}\end{matrix} ] & Eq . 5\end{matrix}$$

The Jones matrix depends on the angle of incidence, azimuth, wavelength as well as structural details of the sample. The diagonal elements describe the complex reflectance (amplitude & phase) for polarization orthogonal (rₛₛ) and parallel (rₚₚ) to the plane of incidence defined by the illumination and collection arms. The off-diagonal terms rₛₚ and rₚₛ are related to polarization conversion between s and p polarization states in the presence of sample anisotropy. The Jones matrix J elements, however, are not easily obtained experimentally. The elements of the 4×4 Mueller matrix M, however, can be derived experimentally.

The matrix T in equation 3 is used to construct the 4×4 Mueller matrix from the Jones matrix and is given by:

$$\\ \begin{matrix}T = ( \begin{matrix}1 & 0 & 0 & 1 \\ 1 & 0 & 0 & - 1 \\ 0 & 1 & 1 & 0 \\ 0 & i & - i & 0\end{matrix} ) & Eq . 6\end{matrix}$$

The Mueller matrix is measured by the optical metrology device 200, and the Jones matrix is calculated from first principles for a given sample. To compare the theoretical (calculated) data to experimental data one needs to convert the Jones matrix to Mueller matrix.

The Mueller matrix M may be written in the Stokes formalism as follows.

$$\\ \begin{matrix}{( \begin{matrix}{s}_{0} \\ {s}_{1} \\ {s}_{2} \\ {s}_{3}\end{matrix} )}^{out} = ( \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ {m}_{41} & {m}_{42} & {m}_{43} & {m}_{44}\end{matrix} ) {( \begin{matrix}{s}_{0} \\ {s}_{1} \\ {s}_{2} \\ {s}_{3}\end{matrix} )}^{in} . & Eq . 7\end{matrix}$$

The Stokes vector S is described as follows.

$$\\ \begin{matrix}S = ( \begin{matrix}{s}_{0} \\ {s}_{1} \\ {s}_{2} \\ {s}_{3}\end{matrix} ) = ( \begin{matrix}{\vert {E}_{s} \vert}^{2} + {\vert {E}_{p} \vert}^{2} \\ {\vert {E}_{s} \vert}^{2} - {\vert {E}_{p} \vert}^{2} \\ 2 Re ( {E}_{s} {E}_{p}^{{}^{} *} ) \\ 2 Im ( {E}_{s} {E}_{p}^{{}^{} *} )\end{matrix} ) = ( \begin{matrix}total powerP \\ {P}_{0 °} - {P}_{90 °} \\ {P}_{45 °} - {P}_{- 45 °} \\ {P}_{RHC} - {P}_{LHC}\end{matrix} ) . & Eq . 8\end{matrix}$$

With the use of optical metrology device 200 with polarizing elements 204, 212 and compensator(s) 205a, 205b, a full Mueller matrix may be measured as follows.

$$\\ \begin{matrix}{M}_{sample} = [ \begin{matrix}\frac{{r}_{pp}^{{}^{} *} {r}_{pp} + {r}_{ss}^{{}^{} *} {r}_{ss} + {r}_{ps}^{{}^{} *} {r}_{ps} + {r}_{sp}^{{}^{} *} {r}_{sp}}{2} & \frac{{r}_{pp}^{{}^{} *} {r}_{pp} - {r}_{ss}^{{}^{} *} {r}_{ss} - {r}_{ps}^{{}^{} *} {r}_{ps} + {r}_{sp}^{{}^{} *} {r}_{sp}}{2} & Re ( {r}_{ps}^{{}^{} *} {r}_{pp} + {r}_{ss}^{{}^{} *} {r}_{sp} ) & - Im ( {r}_{ps}^{{}^{} *} {r}_{pp} + {r}_{ss}^{{}^{} *} {r}_{sp} ) \\ \frac{{r}_{pp}^{{}^{} *} {r}_{pp} - {r}_{ss}^{{}^{} *} {r}_{ss} + {r}_{ps}^{{}^{} *} {r}_{ps} - {r}_{sp}^{{}^{} *} {r}_{sp}}{2} & \frac{{r}_{pp}^{{}^{} *} {r}_{pp} + {r}_{ss}^{{}^{} *} {r}_{ss} - {r}_{ps}^{{}^{} *} {r}_{ps} - {r}_{sp}^{{}^{} *} {r}_{sp}}{2} & Re ( {r}_{ps}^{{}^{} *} {r}_{pp} - {r}_{ss}^{{}^{} *} {r}_{sp} ) & Im ( {r}_{ss}^{{}^{} *} {r}_{sp} - {r}_{ps}^{{}^{} *} {r}_{pp} ) \\ Re ( {r}_{sp}^{{}^{} *} {r}_{pp} + {r}_{ss}^{{}^{} *} {r}_{ps} ) & Re ( {r}_{sp}^{{}^{} *} {r}_{pp} - {r}_{ss}^{{}^{} *} {r}_{ps} ) & Re ( {r}_{ss}^{{}^{} *} {r}_{pp} + {r}_{sp}^{{}^{} *} {r}_{ps} ) & Im ( {r}_{sp}^{{}^{} *} {r}_{ps} - {r}_{ss}^{{}^{} *} {r}_{pp} ) \\ Im ( {r}_{sp}^{{}^{} *} {r}_{pp} + {r}_{ss}^{{}^{} *} {r}_{ps} ) & Im ( {r}_{sp}^{{}^{} *} {r}_{pp} - {r}_{ss}^{{}^{} *} {r}_{ps} ) & Im ( {r}_{ss}^{{}^{} *} {r}_{pp} + {r}_{sp}^{{}^{} *} {r}_{ps} ) & Re ( {r}_{ss}^{{}^{} *} {r}_{pp} - {r}_{sp}^{{}^{} *} {r}_{ps} )\end{matrix} ] & Eq . 9\end{matrix}$$

The optical metrology device 200, e.g., functioning to obtain the Mueller matrix, may be used to characterize complicated 3D devices. For structures that are symmetric along the plane of incidence (POI), the Mueller matrix off-diagonal elements (i.e., mm13, mm14, mm23, mm24, mm31, mm32, mm41, and mm42) are zero due to the mirror symmetry, as illustrated by equation 10.

$$\\ \begin{matrix}MuellerMatrix = ( \begin{matrix}{mm}_{11} & {mm}_{12} & 0 & 0 \\ {mm}_{21} & {mm}_{22} & 0 & 0 \\ 0 & 0 & {mm}_{33} & {mm}_{34} \\ 0 & 0 & {mm}_{43} & {mm}_{44}\end{matrix} ) & Eq . 10\end{matrix}$$

When the mirror symmetry of a symmetric structure is broken due to the selection of the POI, the Mueller matrix off-diagonal elements are non-zero, but Mueller matrix paired off-diagonal elements are zero, as illustrated by equation 11.

$$\\ \begin{matrix}MM\_paired \_off - diagonal\_elements {}^{} \{ \begin{matrix}{mm}_{13} + {mm}_{31} = 0 \\ {mm}_{23} + {mm}_{32} = 0 \\ {mm}_{14} - {mm}_{41} = 0 \\ {mm}_{24} - {mm}_{42} = 0\end{matrix} & Eq . 11\end{matrix}$$

On the other hand, for structures that are asymmetric along the plane of incidence (POI), the Mueller matrix off-diagonal elements are non-zero, as the minor symmetry has been broken, while the Mueller matrix paired off-diagonal elements will not be zero, as illustrated by equation 12.

$$\\ \begin{matrix}MM\_paired \_off - diagonal\_elements {}^{} \{ \begin{matrix}{mm}_{13} + {mm}_{31} \neq 0 \\ {mm}_{23} + {mm}_{32} \neq 0 \\ {mm}_{14} - {mm}_{41} \neq 0 \\ {mm}_{24} - {mm}_{42} \neq 0\end{matrix} & Eq . 12\end{matrix}$$

Accordingly, the Mueller matrix paired off-diagonal elements are uniquely sensitive to structural asymmetry and may be used to characterize process related errors that create the asymmetricity in an otherwise symmetric structure. For example, referring to FIG. 1, the Mueller matrix paired off-diagonal signals will be non-zero due to unequal pitches due to pitch walking (A), unequal CD_1 and CD_2 due to overlay error (B), AirVoidCD misalignment due to overlay error (C), unequal EPI dimensions due to different EPI growth rate (D), and unequal coatings due to different WFM coat rate (E).

The scatterometry measurement performed by the optical metrology device 200 measures an average signal from complicated 3D structures. Using the Mueller matrix measured from a complicated 3D structure by the optical metrology device 200, it is challenging to simultaneously differentiate dimensional parameters (e.g., height, linewidth, side-wall angle, etc.) and asymmetric parameters (e.g., pitch walk, overlay, odd/even CDs, etc.). The Mueller matrix off-diagonal elements are affected by variation of both dimensional parameters and asymmetric parameters, making it difficult to differentiate them using conventional modeling techniques (sometimes referred to as Optical Critical Dimension (OCD) modeling) due to high correlation. As discussed above, the Mueller matrix paired off-diagonal signals (e.g., identified in equations 11 and 12) are primarily dominated by process-induced asymmetric parameters (unless dimensional parameters are process-correlated with asymmetric parameters).

Accordingly, as discussed herein, the asymmetric parameters may be measured using the signal (e.g., spectral) response of the Mueller matrix paired off-diagonal signals using a machine learning approach, which may be fed to one or more OCD models to further improve the measurement accuracy of dimensional parameters. With the input of asymmetric parameters, the accuracy of the OCD model will be improved by suppressing the correlation of the dimensional parameters to the asymmetric parameters. In complex structures, such as a Forksheet device, suppressing the correlation and accurately measuring the asymmetric parameters is particularly useful because asymmetric errors may directly affect device performance.

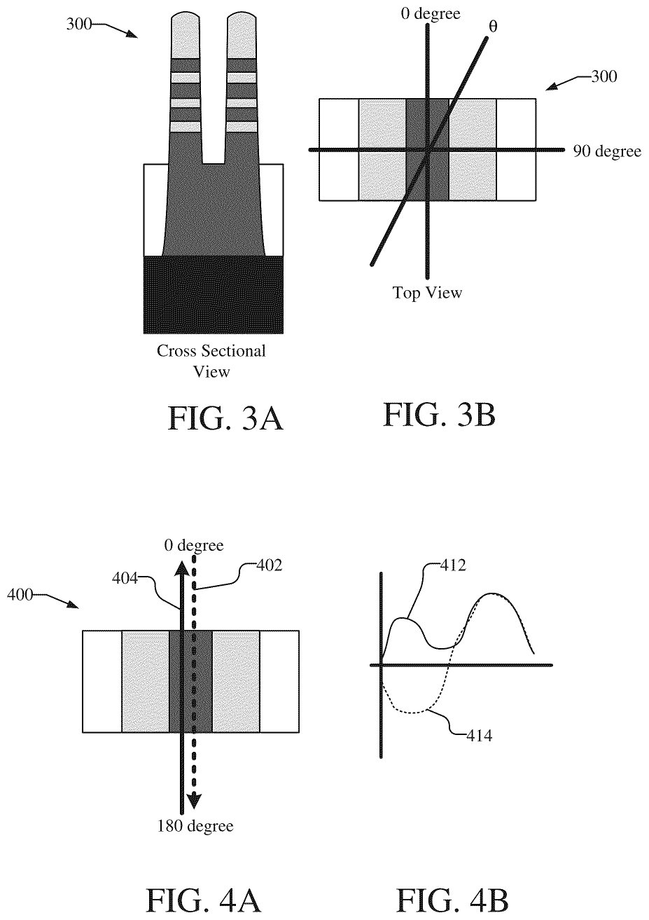

The Mueller matrix paired off-diagonal elements may be more sensitive to key parameters when the optical path (plane of incidence) of the optical metrology device 200 is along some azimuth angles compared to other azimuth angles. FIGS. 3A and 3B, for example, illustrates a cross sectional view and top view, respectively, of a device structure 300 such as a Forksheet device. The model symmetry is determined by both the optical symmetry, e.g., the alignment of the plane of incidence (POI) with the device structure, as well as the geometric symmetry of the device structure. An asymmetric signal exists when the geometric symmetry is broken or when the optical path breaks the model symmetry. As illustrated in FIG. 3B, optical symmetry is present when the azimuth angle of the optical path is along 0° or 90° with respect to the device structure 300. By selecting an azimuth angle other than 0°, 90° or 180°, e.g., along θ the optical path breaks the model symmetry. In some implementations, a sensitivity study may be performed at different azimuth angles to determine which azimuth angles are sensitive to the key parameters, e.g., the highest sensitivity over the key parameters. The sensitivity study may be performed experimentally or through modeling.

Additionally, in some implementations, it is desirable to eliminate tool-induced signals (TIS) on the Mueller matrix paired off-diagonal elements. For example, a misalignment in the optical metrology device 200 may lead to asymmetric signals that may be confused with asymmetric signals caused by process-induced asymmetric parameters in the device structure. By performing measurements at two azimuth angles, e.g., with an interval of 180°, the TIS may be removed.

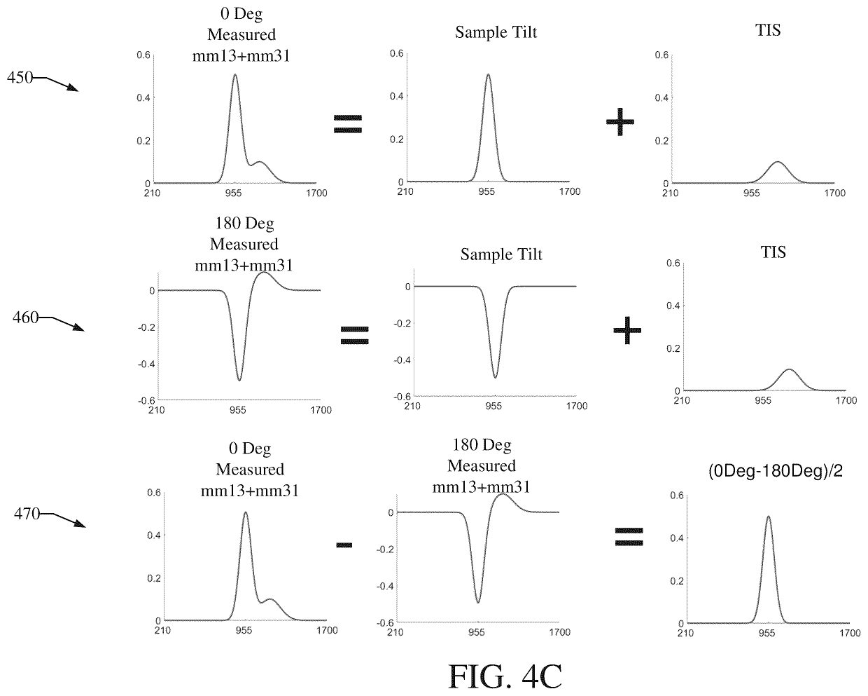

FIGS. 4A and 4B, for example, respectively illustrate a top view of a device structure 400 measured at two different azimuth angles and the resulting measurement signals. As illustrated, in FIG. 4A, the measurement of the device structure 400 may be performed at a first azimuth angle 402 (e.g., 0° (illustrated with dotted arrows)) and a second azimuth angle 404 (e.g., 180° (illustrated with a solid arrows)). The first azimuth angle 402 and second azimuth angle 404 are separated by 180° but may be any desired angles with 180° interval, e.g., selected based on the sensitivity study, and need not be 0° and 180° as illustrated in FIG. 4A. As illustrated in FIG. 4B, the first measurement signal 412 (illustrated with dotted lines) resulting from the first azimuth angle 402 and the second measurement signal 414 (illustrated with sold line) resulting from the second azimuth angle 404 may differ due to the TIS. Accordingly, the measurement data may be pre-processed to remove the TIS based on the difference between the first measurement signal 412 and the second measurement signal 414, which is equivalent to the TIS.

FIG. 4C, by way of example, illustrates with graphs 450 that the signal generated at a first azimuth angle (e.g., 0°) for Mueller matrix paired off-diagonal elements mm13+mm31 is a combination of signal that is in response to the asymmetric shift, e.g., the sample tilt, and the TIS. Graphs 460 similar illustrates that the signal generated at a second azimuth angle (e.g., 180°), which is rotated by 180° from the first azimuth angle for Mueller matrix paired off-diagonal elements mm13+mm31 is also a combination of sample tilt and TIS, with the sample tilt signal inverted, but the TIS not inverted, with respect to the signal generated at the first azimuth angle (shown in graphs 450). As illustrated by graphs 470, subtraction for Mueller matrix paired off-diagonal elements mm13+mm31 measured at the second azimuth angle (e.g., 180° shown in graphs 460) from the first azimuth angle (e.g., 0° shown in graphs 450), which is divided by 2, removes the TIS leaving only the signal that is in response to the asymmetric shift, e.g., the sample tilt.

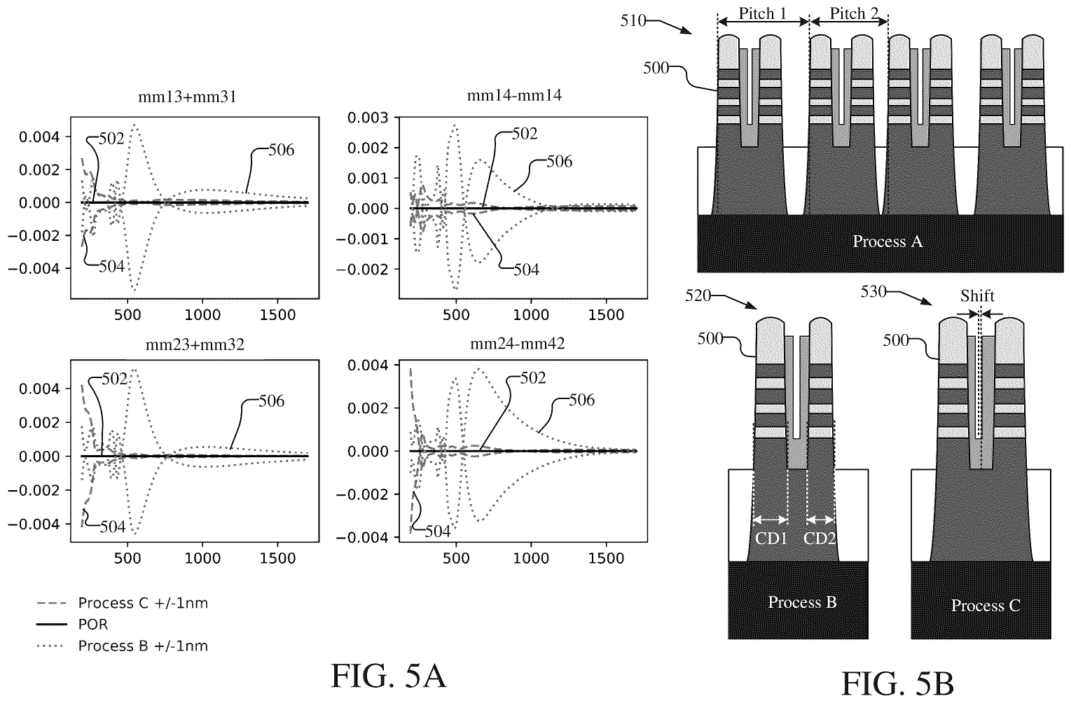

FIGS. 5A and 5B, for example, illustrate an example of measurements of asymmetric parameters of a complicated 3D device structure 500. FIG. 5A, for example, illustrates signals for Mueller matrix paired off-diagonal elements for asymmetric parameters caused by process induced errors and FIG. 5B illustrates the process induced asymmetric parameters in the device structure 500, which in this example is a Forksheet device. For example, in FIG. 5B, view 510 illustrates the process A error of unequal pitches due to pitch walking, view 520 illustrates the process B error of unequal CD_1 and CD_2 due to overlay error, and view 530 illustrates the process C error of AirVoidCD misalignment due to overlay error. For example, FIG. 5A illustrates separate graphs for signals for each Mueller matrix paired off-diagonal elements mm13+mm31, mm23+mm32, mm14−mm41, and mm24−mm42. In FIG. 5A each graph illustrates that the Mueller matrix paired off-diagonal elements are zero for the process of record (POR) with curve 502, and that the Mueller matrix paired off-diagonal elements are non-zero due to the process B error of unequal CD_1 and CD_2 (±1 nm) due to overlay error shown with curve 506 and due to the process C error of AirVoidCD misalignment (±1 nm) due to overlay error with curve 504. Similar graphs may be generated (but are not shown in FIG. 5A) for the asymmetric parameters generated by the combination of process A (unequal pitches) and process B (unequal CD_1 and CD_2) or the combination of process A (unequal pitches) and process C (AirVoidCD misalignment).

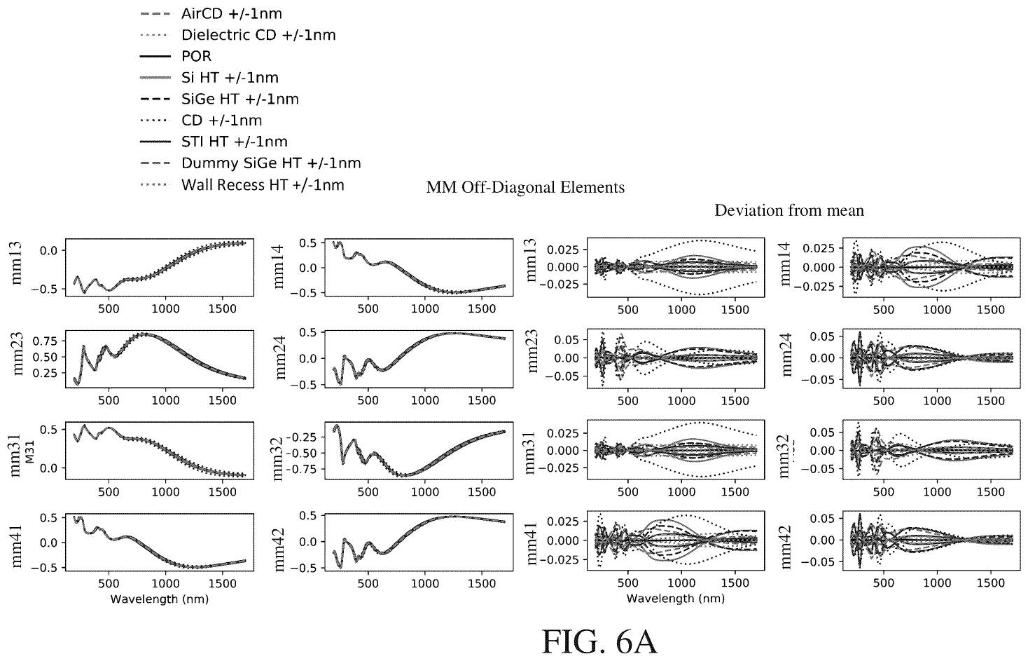

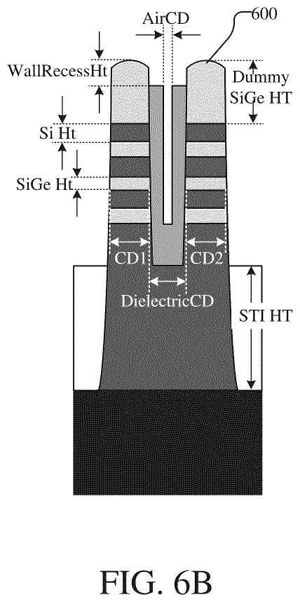

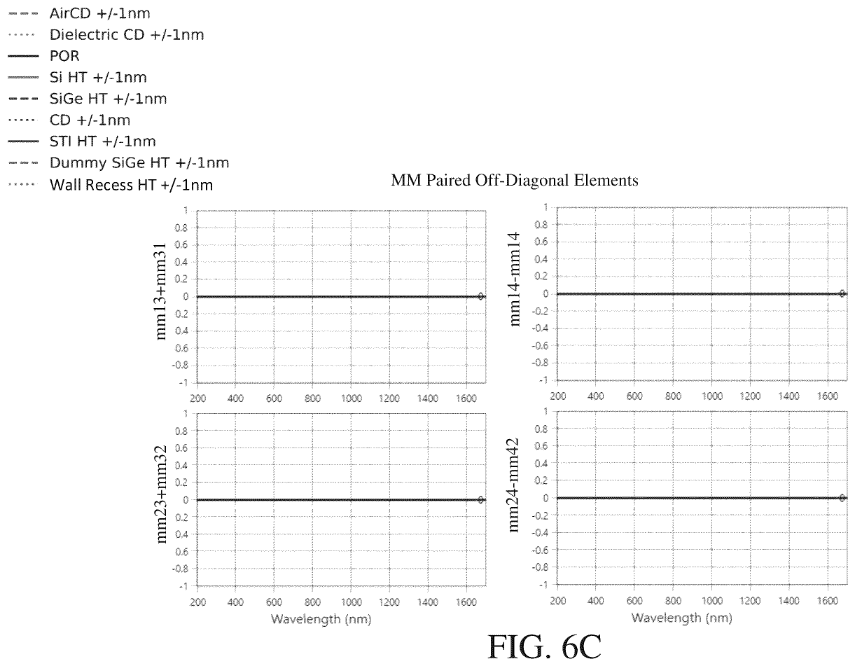

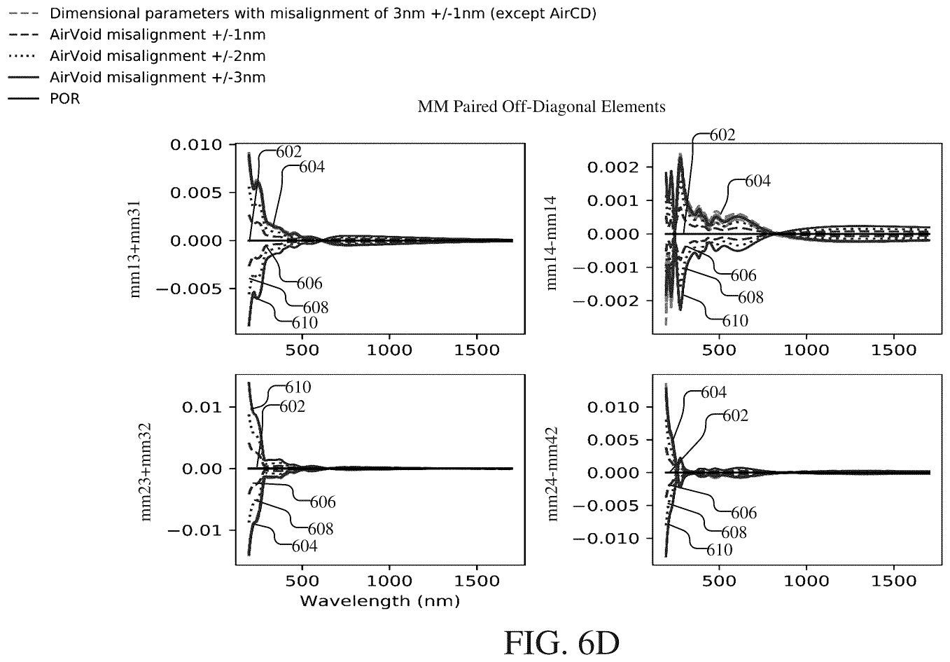

FIGS. 6A, 6B, 6C, and 6D, for example, illustrate an example of measurements of dimensional parameters of a complicated 3D device structure 600. FIG. 6A, for example, illustrates signals for Mueller matrix off-diagonal elements for dimensional parameters and FIG. 6B illustrates the different dimensional parameters in the device structure 600, which in this example is a Forksheet device. For example, FIG. 6A illustrates separate graphs for signals and the deviation from mean for each Mueller matrix off-diagonal elements, mm13, mm14, mm23, mm24, mm31, mm32, mm41, and mm42. In FIG. 6A, each graph illustrates curves for POR, STI height (HT) (±1 nm), CD (±1 nm), Silicon (Si) HT (±1 nm), Si Germanium (Ge) HT (±1 nm), dummy SiGe HT (±1 nm), dielectric CD (±1 nm), AirCD (±1 nm), and Wall Recess HT (±1 nm), as illustrated in FIG. 6B.

FIG. 6C illustrates signals for Mueller matrix paired off-diagonal elements for dimensional parameters of the complicated 3D device structure 600 shown in FIGS. 6A and 6B when the model is symmetric. As illustrated, for a symmetric model, at a chosen azimuth angle (e.g., 135°) the Mueller matrix paired off-diagonal elements are 0. FIG. 6D, on the other hand, illustrates signals for Mueller matrix paired off-diagonal elements for dimensional parameters of the complicated 3D device structure 600 shown in FIG. 6B when the model is asymmetric. For the asymmetric model, at a chosen azimuth angle (e.g., 135°) the Mueller matrix paired off-diagonal elements are affected by both dimensional and asymmetric parameters but are mainly dominated by the asymmetric parameters. FIG. 6D, for example, illustrates signals for Mueller matrix paired off-diagonal elements and illustrates curve 602 for POR, curve 604 for a set of dimensional parameters (STI HT±1 nm, CD±1 nm, Si HT±1 nm, SiGe HT±1 nm, dummy SiGe HT±1 nm, dielectric CD±1 nm, and Wall Recess HT±1 nm) with AirVoid misalignment of 3 nm, curve 606 for AirVoid misalignment of ±1 nm, curve 608 for AirVoid misalignment of ±2 nm, and curve 610 for AirVoid misalignment of ±3 nm. Mueller matrix paired off-diagonal elements of dimensional parameters are non-zero when AirVoid misalignment of ±3 nm exists. However, it overlaps with curve 610, depicting that the signal is dominated by structure asymmetry instead of dimensional parameters.

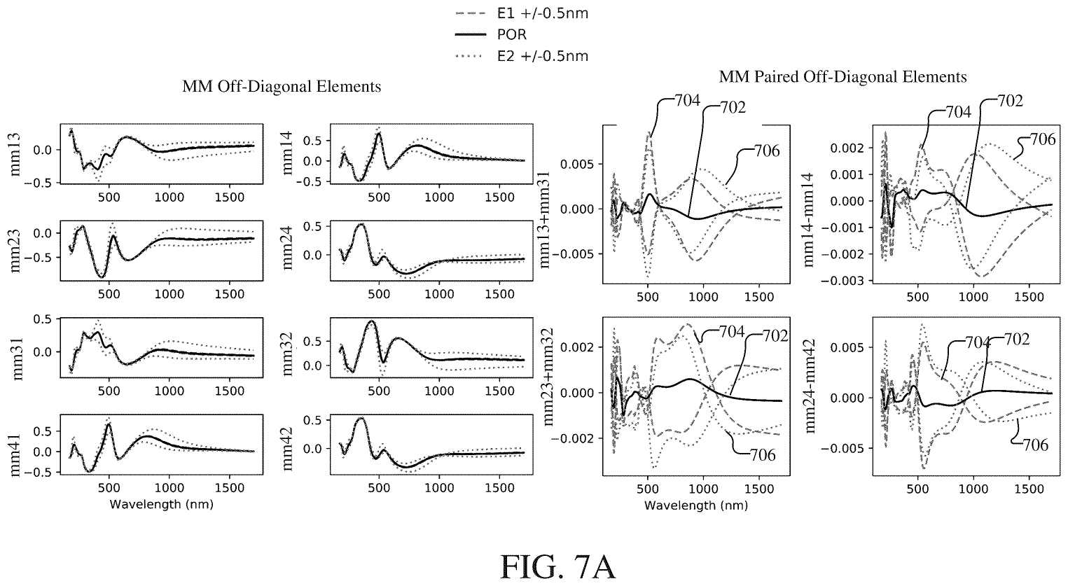

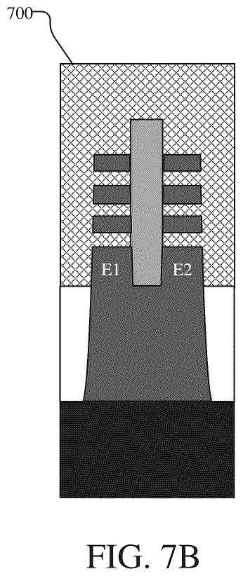

FIGS. 7A and 7B, for example, illustrate an example of measurements of asymmetric parameters of a complicated 3D device structure 700. FIG. 7A, for example, illustrates graphs of signals for Mueller matrix off-diagonal elements mm13, mm14, mm23, mm24, mm31, mm32, mm41, and mm42, on the left, which illustrate no clear differences in the signals when there are unequal coatings of E1 and E2, illustrated in FIG. 7B. FIG. 7A, further illustrates graphs for Mueller matrix paired off-diagonal elements mm13+mm31, mm23+mm32, mm14−mm41, and mm24−mm42, on the right, which illustrate distinctly different signals for POR with curve 702, curve 704 (E1±0.5 nm), and curve 706 (E2±0.5 nm).

Using the Mueller matrix off-diagonal elements, it is challenging to differentiate dimensional parameters (e.g., height, line width, side wall angle, etc.) and asymmetric parameters (e.g., overlay, odd/even CDs, pitch walk, etc.) simultaneously in a complicated 3D device structure. Although the Mueller matrix off-diagonal elements are uniquely generated by asymmetric structures, they are also equally influenced by dimensional parameters once they are generated. However, as illustrated herein, the Mueller matrix paired off-diagonal element signals, are mainly dominated by process induced asymmetric parameters.

Accordingly, a process to measure asymmetric parameters and dimensional parameters of a device using Mueller matrix diagonal elements, may generate machine learning predictions of asymmetric parameters of the device based on paired off-diagonal Mueller matrix elements, and generate dimensional parameters of the device, e.g., using one or more of OCD models and machine learning models, based on the Mueller matrix elements and the asymmetric parameters of the device. In one implementation, for example, the asymmetric parameters determined with the Mueller matrix paired off-diagonal signals using a machine learning approach is fed forward to one or more OCD models to further improve the measurement accuracy of the dimensional parameters. The feed forward of the asymmetry parameters to the OCD model suppresses the correlation between dimensional and asymmetric parameters, resulting in an improved model accuracy and better device performance. In one implementation, the dimensional parameters determined using OCD models may be treated as preliminary dimensional parameters and may be provided to a machine learning model to generate machine learning predictions of dimensional parameters with improved accuracy. In another implementation, one or more OCD models may be generated to determine asymmetry parameters and dimensional parameters of the device sequentially based on the Mueller matrix paired off-diagonal elements and the plurality of Mueller matrix elements, and a machine learning approach may be used to predict the asymmetry parameters and the dimensional parameters of the device based on the OCD models. The use of Mueller matrix paired off-diagonal element signals again breaks the correlation between dimensional and asymmetry parameters thereby simplifying the metrology solution and enabling improvements in accuracy efficiently and effectively.

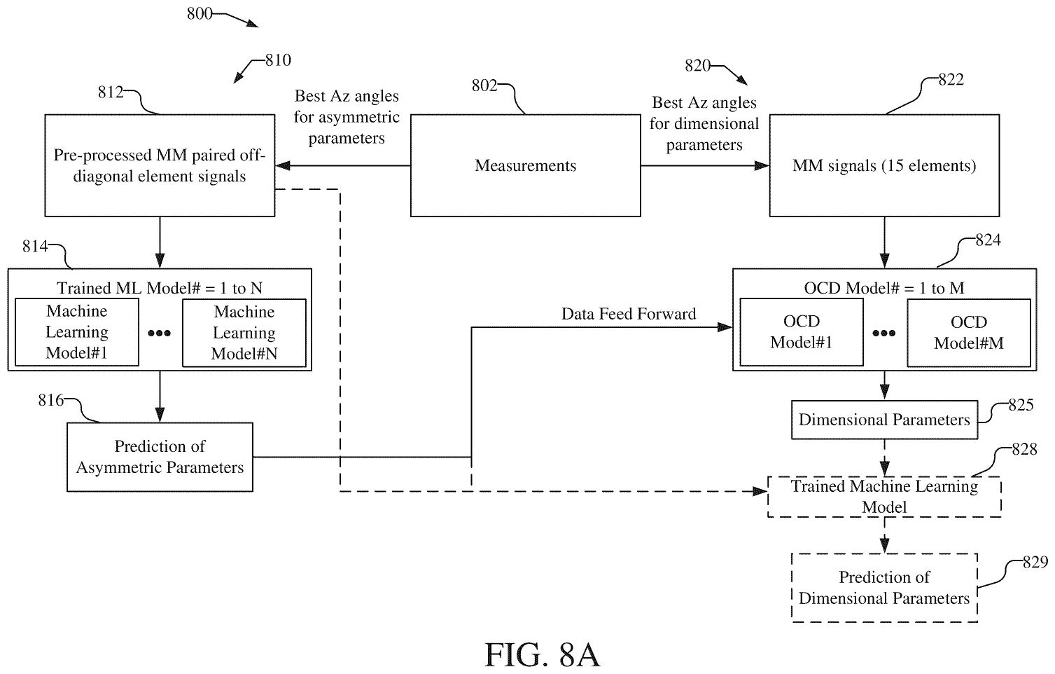

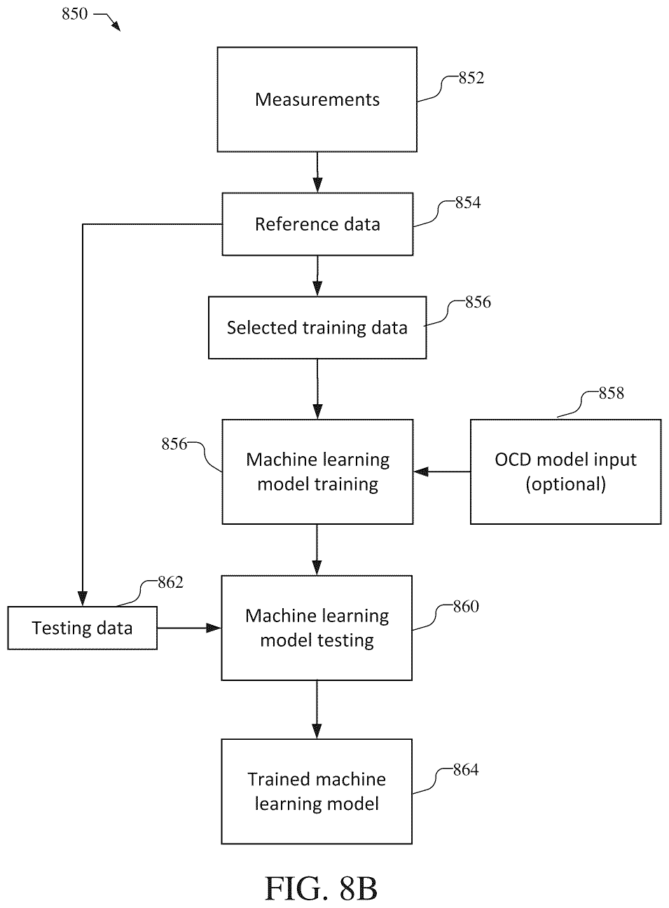

FIG. 8A, by way of example, illustrates a workflow 800 for determining asymmetry parameters and dimensional parameters in accordance with a first example scenario.

As illustrated, measurements are obtained from a 3D sample, such as a FinFET device, a GAA device, Forksheet device, or other complicated 3D device structure (block 802). The measurements may be obtained with optical metrology device 200 shown in FIG. 2 or other similar system. The measurements may be ellipsometric measurements, which may be single wavelength or spectroscopic, or any other type of measurement from which Mueller matrix elements may be determined. Moreover, as discussed in reference to FIGS. 3A and 3B, the measurements may be obtained at different azimuth angles that are sensitive to the key parameters to be determined. For example, the signals to be used for determining asymmetry parameters of the device structure may be obtained at different azimuth angles than the signals to be used for determining dimensional parameters of the device structure. The azimuth angles used to acquire signals for different key parameters may be determined via a sensitivity study, as discussed in FIGS. 3A and 3B. Additionally, as discussed in reference to FIGS. 4A, 4B, and 4C, the signals may be obtained at two azimuth angles with an interval of 180°. For example, for each signal acquired at a first azimuth angle for determining asymmetry parameters of the device structure, a second signal is acquired at a second azimuth angle that is rotated by 180° with respect to the first azimuth angle. If desired, the signals to be used for determining asymmetry parameters of the device structure may be obtained at a plurality of first azimuth angles along with a corresponding plurality of second azimuth angles, each rotated by 180° with respect to an associated first azimuth angle. If desired, the signals to be used for determining dimensional parameters of the device structure may be obtained at a plurality of third azimuth angles. The measurements obtained in block 802 may be provided to a machine learning arm 810 and an OCD modeling arm 820 of the workflow 800.

In the machine learning arm 810, the signals acquired at high sensitivity azimuth angles for characterizing asymmetric parameters may be pre-processed and used to generate one or more Mueller matrix paired off-diagonal element signals (e.g., at least one of mm13+mm31, mm23+mm32, mm14−mm41, and mm24−mm42) (block 812). The signals may be pre-processed, for example, to remove the TIS based on the signals acquired from opposite azimuth angles (e.g., rotated by 180°), as discussed in FIGS. 4A, 4B, and 4C. In some implementations, all of the Mueller matrix paired off-diagonal element signals may be determined, while in other implementations less than all of the Mueller matrix paired off-diagonal element signals may be determined.

The one or more Mueller matrix paired off-diagonal element signals is provided to one or more trained machine learning models (block 814). In some implementations, one machine learning model may be used, and in other implementations, up to N machine learning models may be used. The one or more machine learning models, for example, may be neural network or deep learning models or a combination thereof. The one or more machine learning models may be trained to predict one or more asymmetric parameters of the device structure based on, e.g., the paired off-diagonal elements signals from one or more tools. For example, each machine learning model may be trained to predict one or more asymmetric parameters (block 816) based on the input information of one or more Mueller matrix paired off-diagonal element signals.

Additionally, in the OCD modeling arm 820, the signals acquired (block 802) at high sensitivity azimuth angles for characterizing dimensional parameters are used to generate a plurality of Mueller matrix element signals (block 822). In some implementations, a full Mueller matrix may be generated with 16 Mueller matrix elements, e.g., with one Mueller matrix element used to normalize the remaining 15 Mueller matrix elements for analysis. In other implementations, less than the full Muller matrix may be generated. It should be understood that if the same azimuth angles are used to acquire signals for characterizing asymmetric parameters and dimensional parameters, the plurality of Mueller matrix element signals from block 822 may include the Mueller matrix paired off-diagonal element signals from block 812. If, however, different azimuth angles are used to acquire signals for characterizing asymmetric parameters and dimensional parameters, the plurality of Mueller matrix element signals from block 822 may not include the Mueller matrix paired off-diagonal element signals from block 812.

The plurality of Mueller matrix element signals is provided to one or more OCD models (block 824). Additionally, the predictions of the asymmetric parameters (block 816) are fed forward to the one or more OCD models (block 824). In some implementations, one OCD model may be used, and in other implementations, a number up to M OCD models may be used. The one or more OCD models of the device structure may be used to generate dimensional parameters (block 825) based on modeled (i.e., calculated) Mueller matrix elements generated using the OCD model that is compared with the measured Mueller matrix elements from the device structures. The OCD models may fix asymmetric parameters based on the values of the predictions of the asymmetric parameters fed forward from block 816, while variable parameters of the models for the dimensional parameters are varied and modeled data generated for each variation. The measured Mueller matrix element signals may be compared with the modeled data for each parameter variation, e.g., in a nonlinear regression process, until a good fit is achieved, at which time the values of the fitted dimensional parameters are determined to be an accurate representation of the dimensional parameters of the device structure. In some implementations, a multiple azimuth angle recipe may be used, e.g., with different OCD models used for different azimuth angles. Moreover, in some implementations, multiple OCD models may be used in parallel to determine the dimensional parameters (block 825). In other implementations, the OCD models may be used in series with the dimensional parameters determined from one OCD model fed forward to a subsequent OCD model which may fix the corresponding dimensional parameters to the value of the dimensional parameters during the regression analysis. The asymmetric parameters that are fed forward from block 816 to the one or more OCD models at block 824 suppresses the correlation between dimensional and asymmetric parameters, resulting in an improved model accuracy of the dimensional parameters (block 825) and better device performance.

In some implementations, as illustrated by a dotted lines, the dimensional parameters (block 825) from the one or more OCD models (block 824) may be preliminary dimensional parameters that are provided to trained one or more machine learning models (block 828), which generates predictions for dimensional parameters (block 829) of the device structure. In some implementations illustrated by dotted lines, one or more of the Mueller matrix paired off-diagonal element signals from block 812, the predicted asymmetric parameters from block 816, or both one or more of the Mueller matrix paired off-diagonal element signals from block 812 and the predicted asymmetric parameters from block 816 may be fed forward to the one or more machine learning models at block 828. The one or more machine learning models, for example, may be neural network or deep learning models or a combination thereof. The one or more machine learning models may be trained to predict one or more dimensional parameters of the device structure based on input data. For example, each machine learning model may be trained to predict one or more dimensional parameters (block 829) based on the input information of the dimensional parameters from block 824 and one or more of the Mueller matrix paired off-diagonal element signals from block 812 and/or predicted asymmetric parameters from block 816.

FIG. 8B is a flow chart 850 illustrating a process for training the machine learning models e.g., machine learning models at blocks 814 and 828 in the workflow 800 shown in FIG. 8A.

As illustrated, measurements are obtained from reference samples, such as a FinFET device, a GAA device, a Forksheet device, or other complicated 3D device structures (block 852). The measurements may be obtained with the same optical metrology device to be used with workflow 800 or using different optical metrology device or a number of optical metrology devices. The measurements may be ellipsometric measurements, which may be single wavelength or spectroscopic, or any other type of measurement from which Mueller matrix elements may be determined. The measurements may be acquired at the same azimuth angles to be used for measurements used with workflow 800, but in some implementations, measurements at additional or different azimuth angles may be acquired. In some implementations, the measurements may be obtained synthetically.

Reference data is obtained from third party metrology tools, for example a transmission electron microscope (TEM), a critical dimension scanning electron microscope (CDSEM), high voltage scanning electron microscope (HVSEM), etc. (block 854). The reference data may include asymmetric parameters and/or dimensional parameters, which may be used to label the data. In one implementation, reference data can be synthetically generated using pre-learning model.

Training data is selected from the reference data (block 856). One or more machine learning models (e.g., corresponding to machine learning models in block 814 and/or block 828 of workflow 800) are trained based on the training data. In some implementations, OCD model input (block 858) (e.g., corresponding to OCD models in block 824 of workflow 800) may optionally be provided as input data for training the machine learning models, e.g., particularly for training machine learning models in block 828 of workflow 800.

The machine learning model may be tested (block 860) using testing data (block 862) selected from the reference data (block 854). The trained and tested machine learning model (block 864) may be used for the trained machine learning models in workflow 800.

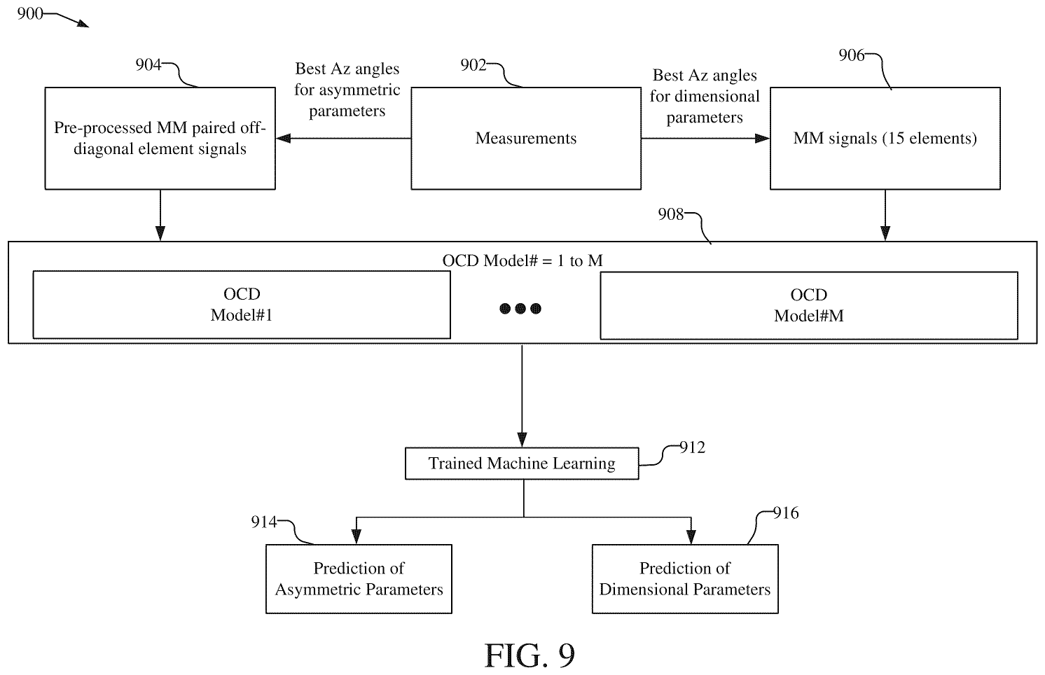

FIG. 9 illustrates a workflow 900 for determining asymmetry parameters and dimensional parameters in accordance with a second example scenario.

As illustrated, similar to block 802 shown in FIG. 8A, measurements are obtained from a 3D sample, such as a FinFET device, a GAA device, a Forksheet device, or other complicated device structure (block 902). The measurements may be obtained with optical metrology device 200 shown in FIG. 2 or other similar device. The measurements may be ellipsometric measurements, which may be single wavelength or spectroscopic, or any other type of measurement from which Mueller matrix elements may be determined. Moreover, as discussed in reference to FIGS. 3A and 3B, the measurements may be obtained at different azimuth angles that are sensitive to the key parameters to be determined. For example, the signals to be used for determining asymmetry parameters of the device structure may be obtained at different azimuth angles than the signals to be used for determining dimensional parameters of the device structure. The azimuth angles used to acquire signals for different key parameters may be determined via a sensitivity study, as discussed in FIGS. 3A and 3B. Additionally, as discussed in reference to FIGS. 4A, 4B, and 4C, the signals may be obtained at two azimuth angles with an interval of 180°. For example, for each signal acquired at a first azimuth angle for determining asymmetry parameters of the device structure, a second signal is acquired at a second azimuth angle that is rotated by 180° with respect to the first azimuth angle. If desired, the signals to be used for determining asymmetry parameters of the device structure may be obtained at a plurality of first azimuth angles along with a corresponding plurality of second azimuth angles, each rotated by 180° with respect to an associated first azimuth angle. If desired, the signals to be used for determining dimensional parameters of the device structure may be obtained at a plurality of third azimuth angles.

The signals acquired at the high sensitivity azimuth angles for characterizing asymmetric parameters may be pre-processed and used to generate one or more Mueller matrix paired off-diagonal element signals (e.g., at least one of mm13+mm31, mm23+mm32, mm14−mm41, and mm24−mm42) (block 904). The signals may be pre-processed, for example, to remove the TIS based on the signals acquired from opposite azimuth angles (e.g., rotated by 180°), as discussed in FIGS. 4A, 4B, and 4C. In some implementations, all of the Mueller matrix paired off-diagonal element signals may be determined.

Additionally, the signals acquired at the high sensitivity azimuth angles for characterizing dimensional parameters are used to generate a plurality of Mueller matrix element signals (block 906). In some implementations, a full Mueller matrix may be generated with 16 Mueller matrix elements, e.g., with one Mueller matrix element used to normalize the remaining 15 Mueller matrix elements for analysis. In other implementations, less than the full Muller matrix may be generated. It should be understood that if the same azimuth angles are used to acquire signals for characterizing asymmetric parameters and dimensional parameters, the plurality of Mueller matrix element signals from block 906 may include the Mueller matrix paired off-diagonal element signals from block 904. If, however, different azimuth angles are used to acquire signals for characterizing asymmetric parameters and dimensional parameters, the plurality of Mueller matrix element signals from block 906 may not include the Mueller matrix paired off-diagonal element signals from block 904.

The one or more Mueller matrix paired off-diagonal element signals from block 904 and the plurality of Mueller matrix element signals from block 906 are provided to one or more OCD models (block 908). The one or more OCD models of the device structure may be used to generate preliminary asymmetric parameters and preliminary dimensional parameters based on modeled (i.e., calculated) Mueller matrix paired off-diagonal element signals and Mueller matrix elements generated using the OCD model that is compared with the measured Mueller matrix paired off-diagonal element signals and plurality of Mueller matrix elements from the device structures. The measured Mueller matrix element signals may be compared with the modeled data for each parameter variation, e.g., in a nonlinear regression process, until a good fit is achieved, at which time the values of the fitted parameters are determined to be an accurate preliminary representation of the parameters of the device structure. The preliminary asymmetric parameters and the preliminary dimensional parameters may be determined sequentially in a series of OCD models. For example, one or more OCD models may be used to generate preliminary asymmetric parameters based on the Mueller matrix paired off-diagonal element signals (from block 904), and the preliminary asymmetric parameters may be fed forward to one or more OCD models that may be used to generate preliminary dimensional parameters based on the Muller matrix element signals (from block 906).

The preliminary asymmetric parameters and the preliminary dimensional parameters from the one or more OCD models (block 908) may be provided to one or more trained machine learning models (block 912). In some implementations, the trained machine learning model may be optional, and the preliminary asymmetric parameters and preliminary dimensional parameters generated by the OCD models (block 908) may be used as the final asymmetric parameters and dimensional parameters. In some implementations, one or more of the Mueller matrix paired off-diagonal element signals from block 904 and/or the Mueller matrix element signals from block 906 may be fed forward to the one or more machine learning models at block 912. The one or more machine learning models, for example, may be neural network or deep learning models or a combination thereof. The one or more machine learning models may be trained to predict one or more asymmetric parameters (block 914) and one or more dimensional parameters (block 916) of the device structure based on input data. The training of the one or more machine learning models, for example, may be the training process discussed in flow chart 850 in FIG. 8B. The determined asymmetric parameters from the one or more OCD models (block 908) and/or from the one or more trained machine learning models (block 912) may be used to suppress the correlation between dimensional and asymmetric parameters, resulting in an improved model accuracy and better device performance.

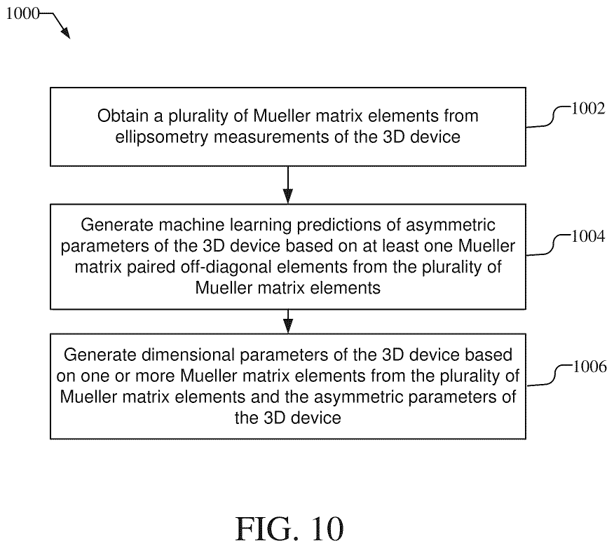

FIG. 10 is a flow chart 1000 illustrating a method for measuring a three-dimensional (3D) device on a sample, as discussed herein. The method, for example, determines asymmetry parameters and dimensional parameters of a 3D device, i.e., a complicated device structure, such as a FinFET device, a GAA device, a Forksheet device, etc., e.g., as discussed herein and particularly in reference to workflow 800 shown in FIG. 8A and/or workflow 900 shown in FIG. 9. The method may be performed, e.g., by the optical metrology device 200 shown in FIG. 2 or other similar device.

At block 1002, a plurality of Mueller matrix elements is obtained from ellipsometry measurements of the 3D device, e.g., as discussed in reference to blocks 802, 812, 822 in FIG. 8A, and blocks 902, 904, and 906 in FIG. 9. In some implementations, the ellipsometry measurements are spectroscopic measurements. A means for obtaining a plurality of Mueller matrix elements from ellipsometry measurements of the 3D device, for example, may be the optical metrology device 200 shown in FIG. 2 or other similar device.

At block 1004, machine learning predictions of asymmetric parameters of the 3D device are generated based on at least one Mueller matrix paired off-diagonal elements from the plurality of Mueller matrix elements, e.g., as discussed in reference to blocks 814 and 816 in FIG. 8A and blocks 904, 908, 912, and 914 of FIG. 9. A means for generating machine learning predictions of asymmetric parameters of the 3D device based on at least one Mueller matrix paired off-diagonal elements from the plurality of Mueller matrix elements, for example, may be one or more trained machine learning models discussed in reference to blocks 814 or 912 shown in FIGS. 8A or 9, respectively, which may be implemented by at least one processor 262 with dedicated hardware or implementing executable code or software instructions in memory 264 such as instructions for the machine learning (ML 267) in FIG. 2.

At block 1006, dimensional parameters of the 3D device are generated based on one or more Mueller matrix elements from the plurality of Mueller matrix elements and the asymmetric parameters of the 3D device, e.g., as discussed in reference to blocks 824, 825, 828, and 829 in FIG. 8A and blocks 906, 908, 912, and 916 of FIG. 9. A means for generating dimensional parameters of the 3D device based on one or more Mueller matrix elements from the plurality of Mueller matrix elements and the asymmetric parameters of the 3D device, for example, may be one or more OCD models, and in some implementations, trained machine learning models, as discussed in reference to blocks 824, 828 or 908, 912 shown in FIG. 8A or 9, respectively, which may be implemented by at least one processor 262 with dedicated hardware or implementing executable code or software instructions in memory 264 such as instructions for the machine learning (ML 267) in FIG. 2.

In some implementations, the ellipsometry measurements of the 3D device to produce the one or more Mueller matrix elements for the dimensional parameters of the 3D device may be performed at different azimuth angles with respect to the 3D device, e.g., as discussed in reference to FIGS. 3A and 3B and blocks 802, 812, 822 in FIG. 8A, and blocks 902, 904, and 906 in FIG. 9. In some implementations, a first one or more to azimuth angles for the ellipsometry measurements of the 3D device to produce the one or more Mueller matrix elements for the dimensional parameters of the 3D device are selected based on sensitivity to the dimensional parameters, e.g., as discussed in reference to FIGS. 3A and 3B.

In some implementation, the ellipsometry measurements of the 3D device to produce the at least one Mueller matrix paired off-diagonal elements for the asymmetric parameters are performed at azimuth angles that are 180° apart, and the plurality of Mueller matrix elements are generated based on a difference between ellipsometry measurements performed with azimuth angles that are 180° apart, e.g., as discussed in reference to FIGS. 4A and 4B and blocks 802, 812, 822 in FIG. 8A, and blocks 902, 904, and 906 in FIG. 9. A means for generating the plurality of Mueller matrix elements based on a difference between ellipsometry measurements performed with azimuth angles that are 180° apart, for example, may be the optical metrology device 200, including stage 209, shown in FIG. 2 or other similar device.

In some implementations, the predictions of asymmetric parameters of the 3D device are fed forward for predicting the dimensional parameters of the 3D device to suppress a correlation between dimensional parameters and asymmetric parameters of the 3D device, e.g., as discussed in reference to blocks 814 and 824 in FIG. 8A and blocks 908 and 912 in FIG. 9.

In some implementations, the machine learning predictions of the asymmetric parameters of the 3D device may be generated based on the at least one Mueller matrix paired off-diagonal elements from the plurality of Mueller matrix elements by providing the at least one Mueller matrix paired off-diagonal elements to a first machine learning model to generate the machine learning predictions of the asymmetric parameters of the 3D device, e.g., as discussed in reference to block 814 of FIG. 8A. A means for providing the at least one Mueller matrix paired off-diagonal elements to a first machine learning model to generate the machine learning predictions of the asymmetric parameters of the 3D device, for example, may be one or more trained machine learning models discussed in reference to block 814 shown in FIG. 8A, which may be implemented by at least one processor 262 with dedicated hardware or implementing executable code or software instructions in memory 264 such as instructions for the machine learning (ML 267) and modeling (Model 266) in FIG. 2. Additionally, in some implementations, the dimensional parameters of the 3D device may be generated based on the at least one or more Mueller matrix elements and the asymmetric parameters of the 3D device by generating preliminary dimensional parameters based on one or more optical critical dimension models using the at least the partial Mueller matrix and the asymmetric parameters of the 3D device, e.g., as discussed in reference to block 824. A means for generating preliminary dimensional parameters based on one or more optical critical dimension models using the one or more Mueller matrix elements and the asymmetric parameters of the 3D device, for example, may be one or more OCD models discussed in reference to block 824 shown in FIG. 8A, which may be implemented by at least one processor 262 with dedicated hardware or implementing executable code or software instructions in memory 264 such as instructions for the modeling (Model 266) in FIG. 2. Additionally, in some implementations, the dimensional parameters of the 3D device may be generated based on the at least the partial Mueller matrix and the asymmetric parameters of the 3D device by further providing the preliminary dimensional parameters to a second one or more machine learning models, e.g., as discussed in reference to blocks 824 and 828 in FIG. 8A, providing at least one of the at least one Mueller matrix paired off-diagonal elements and the machine learning predictions of asymmetric parameters to the second one or more machine learning models, e.g., as discussed in reference to blocks 812, 816 and 828 of FIG. 8A, and generating machine learning predictions of the dimensional parameters of the 3D device based on the preliminary dimensional parameters and the at least one of the at least one Mueller matrix paired off-diagonal elements and the machine learning predictions of asymmetric parameters, e.g., as discussed in reference to block 828 and 829 of FIG. 8A. A means for means for providing the preliminary dimensional parameters to a second one or more machine learning models, for example, may be one or more OCD models discussed in reference to block 824 and trained one or more machine learning models discussed in reference to block 828 shown in FIG. 8A, which may be implemented by at least one processor 262 with dedicated hardware or implementing executable code or software instructions in memory 264 such as instructions for the modeling (Model 266) and machine learning (ML 267) in FIG. 2. A means for providing at least one of the at least one Mueller matrix paired off-diagonal elements and the machine learning predictions of asymmetric parameters to the second one or more machine learning models, for example, may be trained one or more machine learning models discussed in reference to block 828 shown in FIG. 8A, which may be implemented by at least one processor 262 with dedicated hardware or implementing executable code or software instructions in memory 264 such as instructions for the machine learning (ML 267) in FIG. 2. A means for generating machine learning predictions of the dimensional parameters of the 3D device based on the preliminary dimensional parameters and the at least one of the at least one Mueller matrix paired off-diagonal elements and the machine learning predictions of asymmetric parameters, for example, may be trained one or more machine learning models discussed in reference to block 828 shown in FIG. 8A, which may be implemented by at least one processor 262 with dedicated hardware or implementing executable code or software instructions in memory 264 such as instructions for the machine learning (ML 267) in FIG. 2.

In some implementations, the machine learning predictions of the asymmetric parameters of the 3D device may be generated based on the at least one Mueller matrix paired off-diagonal elements from the plurality of Mueller matrix elements and the dimensional parameters of the 3D device may be generated based on the one or more Mueller matrix elements and the asymmetric parameters of the 3D device by generating preliminary asymmetric parameters and preliminary dimensional parameters of the 3D device based on one or more optical critical dimension models using the at least one Mueller matrix paired off-diagonal elements and the one or more Mueller matrix elements, e.g., as discussed in reference to block 908 of FIG. 9. A means for generating preliminary asymmetric parameters and preliminary dimensional parameters of the 3D device based on one or more optical critical dimension models using the at least one Mueller matrix paired off-diagonal elements and the one or more Mueller matrix elements, for example, may be one or more OCD models discussed in reference to block 908 shown in FIG. 9, which may be implemented by at least one processor 262 with dedicated hardware or implementing executable code or software instructions in memory 264 such as instructions for the machine modeling (Model 266) in FIG. 2. Additionally, the preliminary asymmetric parameters and the preliminary dimensional parameters may be provided to one or more machine learning models to generate the machine learning predictions of the asymmetric parameters and machine learning predictions of the dimensional parameters of the 3D device, e.g., as discussed in reference to blocks 908, 912, 914, and 916 of FIG. 9. A means for providing the preliminary asymmetric parameters and the preliminary dimensional parameters to one or more machine learning models to generate the machine learning predictions of the asymmetric parameters and machine learning predictions of the dimensional parameters of the 3D device, for example, may be one or more OCD models discussed in reference to block 908 and one or more trained machine learning models discussed in reference to blocks 908 and 912 shown in FIG. 9, respective, which may be implemented by at least one processor 262 with dedicated hardware or implementing executable code or software instructions in memory 264 such as instructions for the modeling (Model 266) and machine learning (ML 267) in FIG. 2.

The above description is intended to be illustrative, and not restrictive. For example, the above-described examples (or one or more aspects thereof) may be used in combination with each other. Other implementations can be used, such as by one of ordinary skill in the art upon reviewing the above description. Also, various features may be grouped together and less than all features of a particular disclosed implementation may be used. Thus, the following aspects are hereby incorporated into the above description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A method for measuring a three-dimensional (3D) device on a sample, comprising:
obtaining a plurality of Mueller matrix elements from ellipsometry measurements of the 3D device;
generating machine learning predictions of asymmetric parameters of the 3D device based on at least one Mueller matrix paired off-diagonal elements from the plurality of Mueller matrix elements; and
generating dimensional parameters of the 3D device based on one or more Mueller matrix elements from the plurality of Mueller matrix elements and the asymmetric parameters of the 3D device.

2. The method of claim 1, wherein the ellipsometry measurements of the 3D device to produce the at least one Mueller matrix paired off-diagonal elements for the asymmetric parameters and to produce the one or more Mueller matrix elements for the dimensional parameters of the 3D device are spectroscopic measurements.

3. The method of claim 1, wherein the ellipsometry measurements of the 3D device to produce the one or more Mueller matrix elements for the dimensional parameters of the 3D device are performed at different azimuth angles with respect to the 3D device.

4. The method of claim 3, wherein a first one or more azimuth angles for the ellipsometry measurements of the 3D device to produce the one or more Mueller matrix elements for the dimensional parameters of the 3D device are selected based on sensitivity to the dimensional parameters.

5. The method of claim 1, wherein the ellipsometry measurements of the 3D device to produce the at least one Mueller matrix paired off-diagonal elements for the asymmetric parameters are performed at azimuth angles that are 180° apart, wherein the method further comprises:
generating the plurality of Mueller matrix elements based on a difference between ellipsometry measurements performed with azimuth angles that are 180° apart.

6. The method of claim 1, wherein the machine learning predictions of asymmetric parameters of the 3D device are fed forward to one or more optical critical dimension models for generating the dimensional parameters of the 3D device.

7. The method of claim 1, wherein generating the machine learning predictions of the asymmetric parameters of the 3D device based on the at least one Mueller matrix paired off-diagonal elements from the plurality of Mueller matrix elements comprises:
providing the at least one Mueller matrix paired off-diagonal elements to a first machine learning model to generate the machine learning predictions of the asymmetric parameters of the 3D device.

8. The method of claim 7, wherein generating the dimensional parameters of the 3D device based on the one or more Mueller matrix elements and the asymmetric parameters of the 3D device comprises:
generating preliminary dimensional parameters based on one or more optical critical dimension models using the one or more Mueller matrix elements and the asymmetric parameters of the 3D device.

9. The method of claim 8, wherein generating the dimensional parameters of the 3D device based on the one or more Mueller matrix elements and the asymmetric parameters of the 3D device further comprises:
providing the preliminary dimensional parameters to a second one or more machine learning models;
providing at least one of the at least one Mueller matrix paired off-diagonal elements and the machine learning predictions of asymmetric parameters to the second one or more machine learning models; and
generating machine learning predictions of the dimensional parameters of the 3D device based on the preliminary dimensional parameters and the at least one of the at least one Mueller matrix paired off-diagonal elements and the machine learning predictions of asymmetric parameters.

10. The method of claim 1, wherein generating the machine learning predictions of the asymmetric parameters of the 3D device based on the at least one Mueller matrix paired off-diagonal elements from the plurality of Mueller matrix elements and generating the dimensional parameters of the 3D device based on the one or more Mueller matrix elements and the asymmetric parameters of the 3D device comprises:
generating preliminary asymmetric parameters and preliminary dimensional parameters of the 3D device based on one or more optical critical dimension models using the at least one Mueller matrix paired off-diagonal elements and the one or more Mueller matrix elements.

11. The method of claim 10, further comprising:
providing the preliminary asymmetric parameters and the preliminary dimensional parameters to one or more machine learning models to generate the machine learning predictions of the asymmetric parameters and machine learning predictions of the dimensional parameters of the 3D device.

12. An apparatus for measuring a three-dimensional (3D) device on a sample, comprising:
means for obtaining a plurality of Mueller matrix elements from ellipsometry measurements of the 3D device;
means for generating machine learning predictions of asymmetric parameters of the 3D device based on at least one Mueller matrix paired off-diagonal elements from the plurality of Mueller matrix elements; and
means for generating dimensional parameters of the 3D device based on one or more Mueller matrix elements from the plurality of Mueller matrix elements and the asymmetric parameters of the 3D device.

13. The apparatus of claim 12, wherein the ellipsometry measurements of the 3D device to produce the at least one Mueller matrix paired off-diagonal elements for the asymmetric parameters and to produce the one or more Mueller matrix elements for the dimensional parameters of the 3D device are spectroscopic measurements.

14. The apparatus of claim 12, wherein the ellipsometry measurements of the 3D device to produce the one or more Mueller matrix elements for the dimensional parameters of the 3D device are performed at different azimuth angles with respect to the 3D device.

15. The apparatus of claim 14, wherein a first one or more azimuth angles for the ellipsometry measurements of the 3D device to produce the one or more Mueller matrix elements for the dimensional parameters of the 3D device are selected based on sensitivity to the dimensional parameters.

16. The apparatus of claim 12, wherein the ellipsometry measurements of the 3D device to produce the at least one Mueller matrix paired off-diagonal elements for the asymmetric parameters are performed at azimuth angles that are 180° apart, wherein the apparatus further comprises:
means for generating the plurality of Mueller matrix elements based on a difference between ellipsometry measurements performed with azimuth angles that are 180° apart.

17. The apparatus of claim 12, wherein the machine learning predictions of asymmetric parameters of the 3D device are fed forward to one or more optical critical dimension models for generating the dimensional parameters of the 3D device.

18. The apparatus of claim 12, wherein the means for generating the machine learning predictions of the asymmetric parameters of the 3D device based on the at least one Mueller matrix paired off-diagonal elements from the plurality of Mueller matrix elements comprises:
means for providing the at least one Mueller matrix paired off-diagonal elements to a first machine learning model to generate the machine learning predictions of the asymmetric parameters of the 3D device.

19. The apparatus of claim 18, wherein the means for generating the dimensional parameters of the 3D device based on the one or more Mueller matrix elements and the asymmetric parameters of the 3D device comprises:
means for generating preliminary dimensional parameters based on one or more optical critical dimension models using the one or more Mueller matrix elements and the asymmetric parameters of the 3D device.

20. The apparatus of claim 19, wherein the means for generating the dimensional parameters of the 3D device based on the one or more Mueller matrix elements and the asymmetric parameters of the 3D device comprises:
means for providing the preliminary dimensional parameters to a second one or more machine learning models;
means for providing at least one of the at least one Mueller matrix paired off-diagonal elements and the machine learning predictions of asymmetric parameters to the second one or more machine learning models; and
means for generating machine learning predictions of the dimensional parameters of the 3D device based on the preliminary dimensional parameters and the at least one of the at least one Mueller matrix paired off-diagonal elements and the machine learning predictions of asymmetric parameters.

21. The apparatus of claim 12, wherein the means for generating the machine learning predictions of the asymmetric parameters of the 3D device based on the at least one Mueller matrix paired off-diagonal elements from the plurality of Mueller matrix elements and the means for generating the dimensional parameters of the 3D device based on the one or more Mueller matrix elements and the asymmetric parameters of the 3D device comprise:
means for generating preliminary asymmetric parameters and preliminary dimensional parameters of the 3D device based on one or more optical critical dimension models using the at least one Mueller matrix paired off-diagonal elements and the one or more Mueller matrix elements.

22. The apparatus of claim 21, wherein the apparatus further comprises:
means for providing the preliminary asymmetric parameters and the preliminary dimensional parameters to one or more machine learning models to generate the machine learning predictions of the asymmetric parameters and machine learning predictions of the dimensional parameters of the 3D device.

23. An apparatus for measuring a three-dimensional (3D) device on a sample, comprising:
at least one memory; and
a processing system comprising at least one processor coupled to the at least one memory, the processing system configured to:
obtain a plurality of Mueller matrix elements from ellipsometry measurements of the 3D device;
generate machine learning predictions of asymmetric parameters of the 3D device based on at least one Mueller matrix paired off-diagonal elements from the plurality of Mueller matrix elements; and
generate dimensional parameters of the 3D device based on one or more Mueller matrix elements from the plurality of Mueller matrix elements and the asymmetric parameters of the 3D device.
